(19) United States
(12) Patent Application Publication
(10) Pub. No.: US 2022/0135144 A1
(43) Pub. Date: May 5, 2022

(54) VEHICLE STRUCTURE AND METHOD FOR COATING VEHICLE

(71) Applicant: TOYOTA JIDOSHA KABUSHIKI KAISHA, Toyota-shi (JP)

(72) Inventors: Yuki NAGANUMA, Nagoya-shi (JP); Junya OGAWA, Okazaki-shi (JP); Hidetaka ASANO, Nisshin-shi (JP)

(21) Appl. No.: 17/498,036

(22) Filed: Oct. 11, 2021

(30) Foreign Application Priority Data
Oct. 29, 2020 (JP) 2020-181640

(51) Int. Cl. B62D 29/04

(52) U.S. Cl. CPC B62D 29/04

(57) ABSTRACT

A vehicle structure and a method for coating a vehicle capable of easily stripping a coating. The vehicle structure includes an outer panel and an exterior component, and a strippable coating formed by applying easily strippable coating material onto the outer panel and exterior component. A long member having a higher rigidity than the coating is disposed in a part between at least one of the outer panel or the exterior component and the coating.

### CROSS REFERENCE TO RELATED APPLICATIONS

The present application claims priority from Japanese patent application JP 2020-181640 filed on Oct. 29, 2020, the entire content of which is hereby incorporated by reference into this application.

### BACKGROUND

### Technical Field

The present disclosure relates to a vehicle structure and a method for coating a vehicle.

### Background Art

For example, JP H06-142604 A discloses a technique of temporarily protecting the painted surface of a painted vehicle during transportation, by forming an easily strippable coating on the painted surface and then stripping it after transportation. The coating includes layers obtained through application of strippable paint using a roller and by spraying.

### SUMMARY

Development has recently been made on forming a strippable coating by applying easily strippable coating material onto the surface of a vehicle. However, there has been a problem in that since the stress concentration of the stripping force likely occurs when the strippable coating is stripped, the coating partially breaks, thereby making it difficult to strip the coating.

The present disclosure has been made in view of the aforementioned technical issue, and provides a vehicle structure and a method for coating a vehicle that can facilitate stripping the coating.

The vehicle structure according to the present disclosure includes an outer panel and an exterior component of a vehicle, and a strippable coating formed by applying easily strippable coating material onto the outer panel and the exterior component, in which a long member having a higher rigidity than the coating is disposed in a part between at least one of the outer panel or the exterior component and the coating.

In the vehicle structure according to the present disclosure, since the long member having a higher rigidity than the coating is disposed in a part between at least one of the outer panel or the exterior component and the coating, the stripping force can be substantially uniformly applied onto the coating using the long member, so that breaking of the coating due to the stress concentration of the stripping force can be prevented. Moreover, the coating can be stripped while being wound around the long member. As a result, the coating can be easily stripped.

In the vehicle structure according to the present disclosure, the long member may be disposed on a backside surface of at least one of the outer panel or the exterior component in some embodiments. This allows easy stripping of the coating without affecting the designability of the vehicle by the disposed long member.

In the vehicle structure according to the present disclosure, the long member may have a cross section widened from the inner side toward the outer side of the vehicle in some embodiments. With such a structure, a portion having a relatively large width of the long member is oriented toward the outer side of the vehicle, which allows the operator to easily hold the long member. Meanwhile, since a portion having a relatively small width of the long member contacts the surface of the outer panel or the exterior component of the vehicle, the contact area between the long member and the surface of the outer panel or the exterior component of the vehicle is reduced, so that the coating can be easily stripped.

In the vehicle structure according to the present disclosure, the long member may be disposed near a start point for stripping the coating in some embodiments. Such a structure reduces the distance between the start point for stripping and the long member, so that the breaking of the coating in a portion between the start point for stripping and the long member can be suppressed.

Further, the present disclosure provides a method for coating a vehicle including an outer panel and an exterior component of the vehicle and a strippable coating formed by applying easily strippable coating material onto the outer panel and the exterior component, in which the coating material is applied to form the coating with a long member disposed in a part between at least one of the outer panel or the exterior component and the coating to be formed, the long member having a higher rigidity than the coating to be formed.

In the method for coating a vehicle according to the present disclosure, since the coating material is applied to form the coating with the long member disposed in a part between at least one of the outer panel or the exterior component and the coating to be formed, the long member having a higher rigidity than the coating to be formed, the long member is partially interposed between the formed coating and the outer panel or the exterior component of the vehicle. Further, when stripping the coating, the stripping force can be substantially uniformly applied onto the coating using the long member, so that breaking of the coating due to the stress concentration of the stripping force can be prevented. Moreover, the coating can be stripped while being wound around the long member. As a result, the coating can be easily stripped.

According to the present disclosure, a coating can be easily stripped.

### BRIEF DESCRIPTION OF THE DRAWINGS

FIG. 1 is a perspective view showing a vehicle structure according to a first embodiment;

FIG. 2 is a schematic cross-sectional view showing a hood panel, a coating formed on the hood panel, and a long member;

FIG. 3A is a schematic cross-sectional view showing an example of the coating with a clear layer formed on the outer side of the coating;

FIG. 3B is a schematic cross-sectional view showing an example of the coating directly formed on an electrodeposited layer;

FIG. 3C is a schematic cross-sectional view showing an example of the coating formed on the electrodeposited layer, with the clear layer further formed on the outer side of the coating;

FIG. 4 is a schematic cross-sectional view showing a front bumper cover, the coating formed on the front bumper cover, and the long member;

FIG. 5 is a schematic view showing an example of a second embodiment in which the long member is disposed on a backside surface of the front bumper cover; and

FIG. 6 is a transverse-sectional view showing modifications of the long member.

### DETAILED DESCRIPTION

With reference to the drawings, an embodiment of a vehicle structure and a method for coating a vehicle according to the present disclosure will be described below. The vehicle referred to in the present embodiment includes automobiles and trains. Herein, a passenger car of the automobiles will be described as an example.

### [First Embodiment]

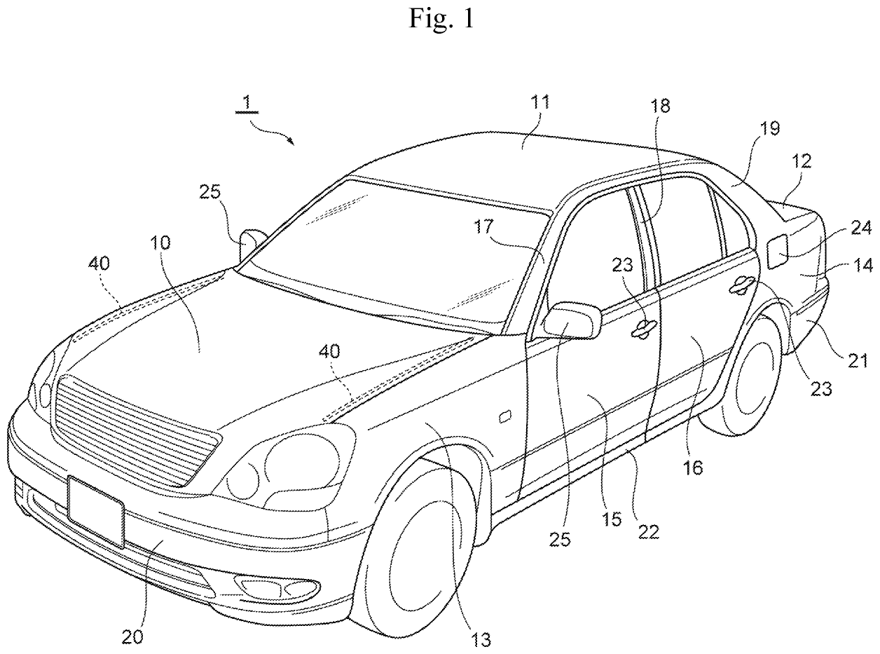

FIG. 1 is a perspective view showing a vehicle structure according to a first embodiment. As shown in FIG. 1, a vehicle 1 includes a plurality of outer panels and exterior components. The outer panels herein are externally visible members (in other words, visible from the outside of the vehicle) constituting the vehicle body. Examples of the outer panel include a hood panel 10, a roof panel 11, a trunk lid 12, a front fender panel 13, a rear fender panel 14, a front door outer 15, a rear door outer 16, a front pillar 17, a center pillar 18, and a rear pillar 19. The examples of the material adopted for the outer panels include hot-rolled sheet steel or cold-rolled sheet steel.

Meanwhile, the exterior components of the vehicle 1 are externally visible fittings to be assembled into the vehicle body. Examples of the exterior component include a front bumper cover 20, a rear bumper cover 21, a rocker panel molding 22, a door handle 23, a fuel filler cover 24, a side-view mirror 25, a shark fin (not shown), and a roof molding (not shown). The material mainly adopted for the exterior components is resin, but the fuel filler cover 24 is mostly formed of sheet steel.

A strippable coating 30 is formed on each of the aforementioned outer panels and exterior components. More specifically, the strippable coating 30 formed through application of easily strippable coating material is provided on the outer surface and side end surface and also a part of the backside surface of each of these outer panels and exterior components.

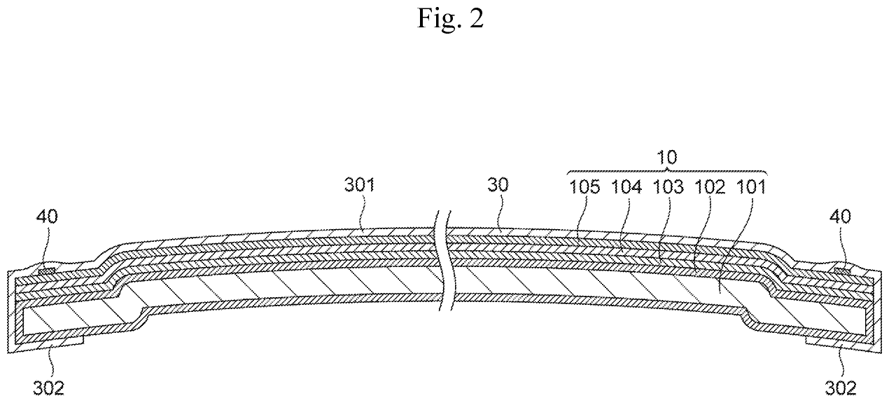

With reference to FIG. 2 to FIG. 4, the coating 30 formed on the outer panel and the exterior component, and a long member 40 disposed in a part between the outer panel or the exterior component and the coating 30 will be described. First, the description of the outer panel will be made by presenting an example of the hood panel 10.

FIG. 2 is a schematic cross-sectional view showing a hood panel, a coating formed on the hood panel, and a long member. In the drawing of FIG. 2, the upper side is the front side (that is, the outer side of the vehicle) of the hood panel 10, the lower side is the back side (that is, the inner side of the vehicle) of the hood panel 10, the left side is the left side (that is, the left side of the vehicle) of the hood panel 10, and the right side is the right side (that is, the right side of the vehicle) of the hood panel 10. As shown in FIG. 2, the hood panel 10 includes a sheet steel 101 that is metal-processed in the form of a hood, an electrodeposited layer 102 formed so as to cover the entire sheet steel 101, and an intermediate coating layer 103, a base layer 104, and a clear layer 105 that are formed in this order on the electrodeposited layer 102 on the front side of the hood panel 10.

Further, the coating 30 is formed on the entire outer surface and side end surface and on a part of the backside surface of the hood panel 10. The coating 30 is formed through application of easily strippable coating material as described above, thus having an easily strippable property as compared to the typical coating including the electrodeposited layer 102, the intermediate coating layer 103, the base layer 104, and the clear layer 105.

The coating 30 includes a design portion 301 formed on the outer surface of the hood panel 10, and a non-design portion 302 coupled to the design portion 301 and formed on the entire side end surface and on a part of the backside surface of the hood panel 10. That is, when the hood panel 10 is mounted on the vehicle 1, the design portion 301 is an externally visible portion of the coating 30, and the non-design portion 302 is an externally invisible portion of the coating 30. It should be noted that the side end surface of the hood panel 10 refers to the peripheral end face extending in the longitudinal and lateral directions of the vehicle 1.

The coating 30 is formed by, for example, spraying easily strippable coating material onto the hood panel 10. Examples of the easily strippable coating material include coating materials made from xylene, ethylbenzene, an antioxidant, methyl ethyl ketone, a silica reactant, a titanium oxide (nanoparticles), an organic solvent, and the like.

Further, the long member 40 having a higher rigidity than the coating 30 is disposed in a part between the hood panel 10 and the coating 30. Specifically, as shown in FIG. 2, the flat long member 40 is partially interposed between the outer surface of the hood panel 10 and the design portion 301 of the coating 30. The long member 40 has a rectangular transverse section and extends from one end to the other end of the hood panel 10 along the longitudinal direction of the vehicle 1 (see FIG. 1). The long member 40 is formed of a resin material or a metal material having a higher rigidity than the coating, and is resin-molded or metal-processed so as to follow the shape of the hood panel 10. It should be noted that the transverse section herein refers to the cross section perpendicular to the longitudinal direction of the long member 40.

As shown in FIG. 1, the long members 40 are formed in a left and right pair and disposed near the left and right opposite ends of the hood panel 10 so as to be symmetrical about the center of the hood panel 10. With such an arrangement, even when the disposed long members 40 cause unevenness on the coating 30, the unevenness on the left and right sides appears to be symmetrical and can thus be exhibited as if it is intentionally created for a better designability of the hood panel 10. As a result, the influence of the disposed long members 40 on the aesthetic appearance of the hood panel 10 can be suppressed.

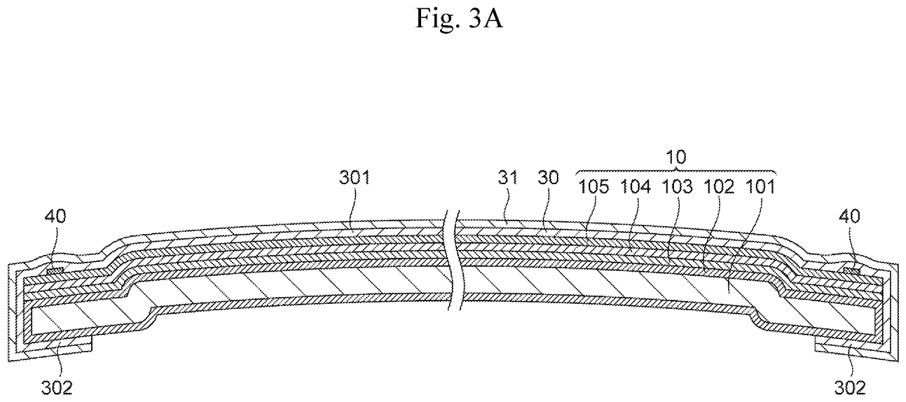

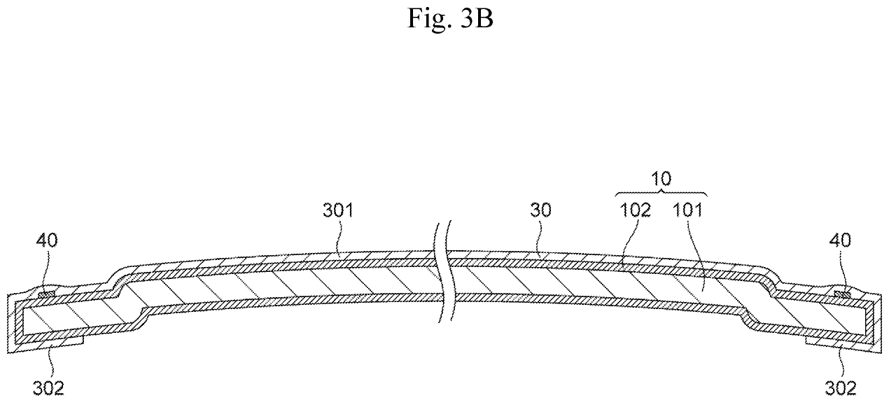

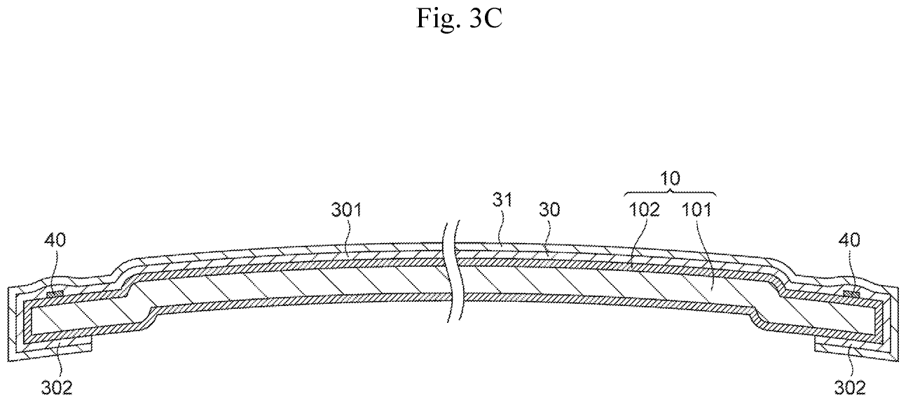

Further, a clear layer 31 may be further formed on the outer side of the coating 30 (see FIG. 3A). With the clear layer 31 formed as such, the weather resistance and chemical resistance of the coating 30 can be enhanced, and the sleek and luxurious appearance can also be further distinguished.

It should be noted that the hood panel 10 does not necessarily include the sheet steel 101, the electrodeposited layer 102, the intermediate coating layer 103, the base layer 104, and the clear layer 105, but may only include the sheet steel 101 and the electrodeposited layer 102, for example, as shown in FIG. 3B. In this case, the coating 30 is formed directly on the electrodeposited layer 102. Further, in this case also, the clear layer 31 may be further formed on the outer side of the coating 30 (see FIG. 3C).

The coating 30 provided on the outer panel and the long member 40 disposed in a part between the outer panel and the coating 30 have been described above by presenting the example of the hood panel 10. The description similarly applies to the other outer panels, such as the roof panel 11, trunk lid 12, front fender panel 13, rear fender panel 14, front door outer 15, rear door outer 16, front pillar 17, center pillar 18, and rear pillar 19. Thus, the overlapping description will be omitted.

Next, the coating 30 formed on the exterior component and the long member 40 disposed in a part between the exterior component and the coating 30 will be described by presenting an example of the front bumper cover 20.

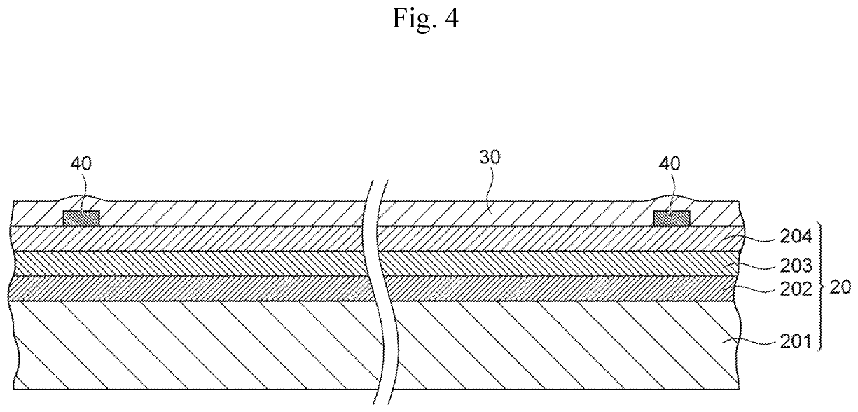

FIG. 4 is a schematic cross-sectional view showing the front bumper cover, the coating formed on the front bumper cover, and the long member. In the drawing of FIG. 4, the upper side is the front side (that is, the outer side of the vehicle) of the front bumper cover 20, the lower side is the backside (that is, the inner side of the vehicle) of the front bumper cover 20, the left side is the left side (that is, the left side of the vehicle) of the front bumper cover 20, and the right side is the right side (that is, the right side of the vehicle) of the front bumper cover 20. The front bumper cover 20 includes a resin member 201 integrally molded in a bumper form, and a primer layer 202, a base layer 203, and a clear layer 204 that are formed in this order on the resin member 201. Further, the coating 30 is formed on the entire outer surface and side end surface and on a part of the backside surface of the front bumper cover 20. It should be noted that the aforementioned clear layer 31 may be further formed on the outer side of the coating 30.

The long member 40 is disposed in a part between the outer surface of the front bumper cover 20 and the coating 30. The long member 40 has a rectangular transverse section and is disposed at each of the left and right opposite ends of the front bumper cover 20 so that the long members 40 are symmetrical about the center of the front bumper cover 20. Further, though not shown, the long member 40 is resin-molded or metal-processed so as to follow the shape of the front bumper cover 20 and extends from one end to the other end along the direction perpendicular to the longitudinal direction of the front bumper cover 20 (that is, in the vertical direction of the vehicle).

Further, similarly to the front bumper cover 20, the coating 30 is formed on and the long member 40 is disposed in the exterior components made of resin such as the rear bumper cover 21, the rocker panel molding 22, and the door handle 23. Thus, the overlapping description will be omitted. It should be noted that when the fuel filler cover 24 is formed of sheet steel, the structure similar to that of the aforementioned hood panel 10 is applied.

In the structure of the vehicle 1 according to the present embodiment, since the long member 40 having a higher rigidity than the coating 30 is disposed in a part between the outer panel and the coating 30 and in a part between the exterior component and the coating 30, the stripping force can be substantially uniformly applied onto the coating 30 using the long member 40, so that breaking of the coating 30 due to the stress concentration of the stripping force can be prevented. Moreover, the coating 30 can be stripped while being wound around the long member 40. As a result, the coating 30 can be easily stripped.

It should be noted that in the present embodiment, the long member 40 is not necessarily disposed in each of parts between the outer panel and the coating 30 and between the exterior component and the coating 30, and may be disposed, for example, only between the outer panel and the coating 30 or between the exterior component and the coating 30. Further, the long member 40 is not necessarily disposed in all the outer panels or the exterior components. Whether to dispose the long member 40 may be determined in accordance with the size, shape, and the like of the outer panel and exterior component.

In coating the vehicle 1 according to the present embodiment, the coating 30 is formed by applying easily strippable coating material onto the outer panel and exterior component, with the long member 40, which has a higher rigidity than the coating 30 to be formed, disposed in a part between at least one of the outer panel or the exterior component and the coating 30 to be formed. In the case of the hood panel 10, for example, the long member 40 is disposed in a predetermined position at each of the left and right opposite ends of the hood panel 10 such that the longitudinal direction of the long member 40 corresponds to the longitudinal direction of the vehicle 1. At this time, to prevent the positional deviation of the long member 40, for example, the long member 40 may be lightly secured with an adhesive or the like. Then, with the long member 40 disposed, the easily strippable coating material is sprayed onto the hood panel 10 to form the coating 30. The clear layer 31 may be further formed on the coating 30 after the formed coating 30 is dried.

In the method for coating the vehicle 1 according to the present embodiment, the coating 30 is formed through application of easily strippable coating material, with the long member 40, which has a higher rigidity than the coating 30 to be formed, disposed in a part between at least one of the outer panel or the exterior component and the coating 30 to be formed, so that the long member 40 is partially interposed between the formed coating 30 and the outer panel or the exterior component. Thus, the stripping force in stripping the coating 30 can be substantially uniformly applied onto the coating 30 using the long member 40, so that breaking of the coating 30 due to the stress concentration of the stripping force can be prevented. Moreover, the coating 30 can be stripped while being wound around the long member 40. As a result, the coating 30 can be easily stripped.

### [Second Embodiment]

The structure of the vehicle 1 according to a second embodiment is the same as that of the aforementioned first embodiment, except that the long member 40 is disposed on the backside surface of the outer panel or the exterior component. The long member 40 disposed on the backside surface of the outer panel or the exterior component will be described below by presenting an example of the front bumper cover 20.

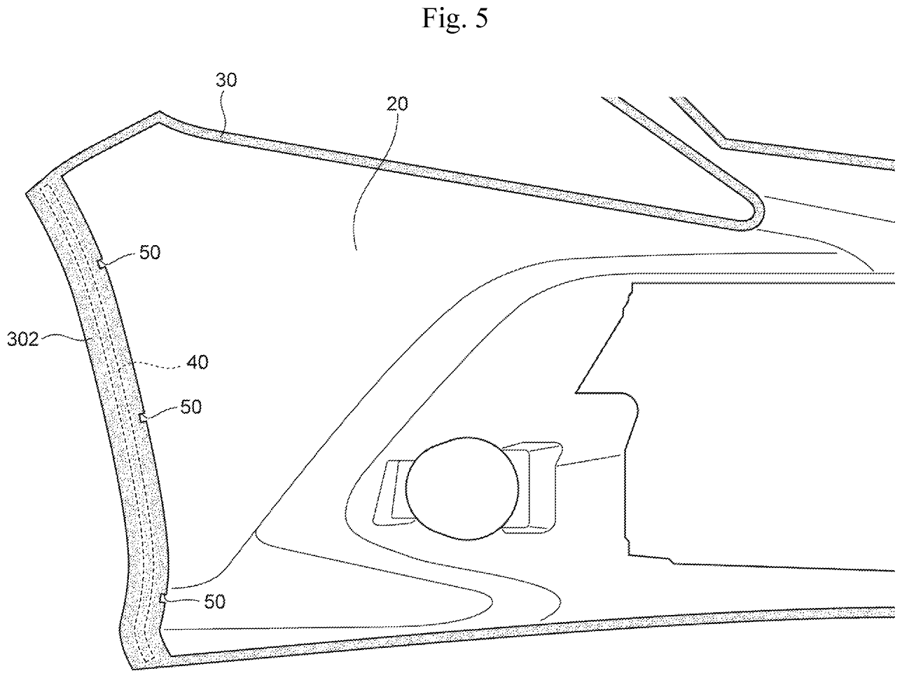

FIG. 5 is a schematic view showing an example of the second embodiment in which the long member is disposed on the backside surface of the front bumper cover. FIG. 5 only shows a left side portion of the backside surface of the front bumper cover 20, and depicts the coating 30 with a dotted pattern for easy recognition. As shown in FIG. 5, the non-design portion 302 of the coating 30 is formed on the backside surface of the front bumper cover 20. Further, the long member 40 is partially interposed between the backside surface of the front bumper cover 20 and the non-design portion 302 of the coating 30.

Specifically, the long member 40 is disposed in a part between the backside surface of the front bumper cover 20 and the non-design portion 302 at each of the left and right opposite ends of the front bumper cover 20. The long member 40 extends from one end to the other end along the direction perpendicular to the longitudinal direction of the front bumper cover 20 (that is, in the vertical direction of the vehicle).

Further, a plurality of start points 50 for stripping the coating 30 is provided at an edge portion of the non-design portion 302 of the coating 30. These start points 50 for stripping are cuts formed by cutting out portions in a rectangular shape from the non-design portion 302 using a cutter or the like, and are substantially equidistantly arranged along the edge portion of the non-design portion 302. It should be noted that the shape of the start point 50 for stripping may be a rectangular shape, wave-like shape, saw-like shape, or the like. The long member 40 is disposed near these start points 50 for stripping.

According to the present embodiment, the effects similar to those of the aforementioned first embodiment can be obtained, and in addition, since the long member 40 is disposed on the backside surface of the front bumper cover 20, the coating 30 can be easily stripped without affecting the designability of the vehicle 1. Further, since the long member 40 is disposed near the start points 50 for stripping the coating 30, the distance between each of the start points 50 for stripping and the long member 40 is reduced, so that breaking of the coating 30 in portions between the start points 50 for stripping and the long member 40 can be suppressed.

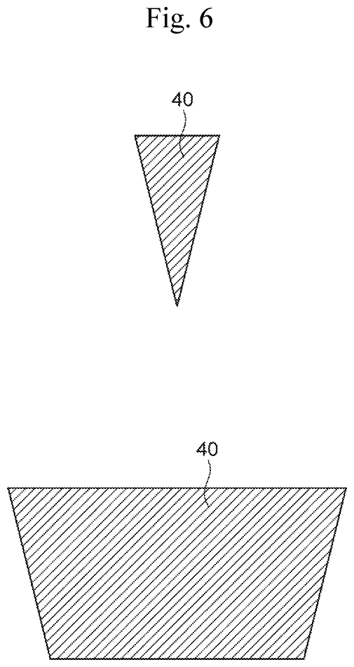

It should be noted that the transverse section of the long member 40 is not limited to be in a rectangular, but may be in various shapes as modifications. For example, the long member 40 may have a cross section widened from the inner side toward the outer side of the vehicle 1. Specifically, the long member 40 may have a transverse section in an isosceles triangle (see the figure on the upper side of FIG. 6) or a transverse section in an isosceles trapezoid (see the figure on the lower side of FIG. 6). With such a structure, a portion having a relatively large width of the long member 40 is oriented toward the outer side of the vehicle 1, which allows the operator to easily hold the long member 40 in stripping the long member 40. Meanwhile, since a portion having a relatively small width of the long member 40 contacts the surface of the outer panel or the exterior component of the vehicle 1, the contact area between the long member 40 and the surface of the outer panel or the exterior component is reduced, so that the coating 30 can be easily stripped.

It should be noted that as long as the long member 40 has a cross section widened from the inner side toward the outer side of the vehicle 1, the shape of the long member 40 may also be a triangle other than the aforementioned isosceles triangle, a trapezoid other than the isosceles trapezoid, or a polygon. Further, the long member 40 may have a round transverse section.

Although the embodiment of the present disclosure has been described in detail, the present disclosure is not limited thereto, and various design changes can be made without departing from the spirit of the present disclosure described in the scope of the claims.

For example, although in the aforementioned embodiments, the example of the long members 40 in a left and right pair symmetrically disposed has been described, only one, or three or more long members 40 may be disposed in each of the outer panels or the exterior components. In particular, when the long member 40 is disposed on the backside surface of the outer panel or the exterior component, since the designability of the vehicle 1 is not affected, a plurality of long members 40 may be asymmetrically disposed.

What is claimed is:

1. A vehicle structure comprising:
an outer panel and an exterior component of a vehicle; and
a strippable coating formed by applying easily strippable coating material onto the outer panel and the exterior component,
wherein a long member having a higher rigidity than the coating is disposed in a part between at least one of the outer panel or the exterior component and the coating.

2. The vehicle structure according to claim 1, wherein the long member is disposed on a backside surface of at least one of the outer panel or the exterior component.

3. The vehicle structure according to claim 1, wherein the long member has a cross section widened from an inner side toward an outer side of the vehicle.

4. The vehicle structure according to claim 1, wherein the long member is disposed near a start point for stripping the coating.

5. A method for coating a vehicle including an outer panel and an exterior component of the vehicle and a strippable coating formed by applying easily strippable coating material onto the outer panel and the exterior component,
wherein the coating material is applied to form the coating with a long member disposed in a part between at least one of the outer panel or the exterior component and the coating to be formed, the long member having a higher rigidity than the coating to be formed.
